(19) United States
(12) Patent Application Publication
(10) Pub. No.: US 2012/0094049 A1
(43) Pub. Date: Apr. 19, 2012

(54) TALC AS A FIRE PERFORMANCE MODIFIER IN POLYMER COMPOSITIONS

(76) Inventor: James M. Killough, Houston, TX (US)

(21) Appl. No.: 12/906,034

(22) Filed: Oct. 15, 2010

(51) Int. Cl. B32B 1/02; C01B 33/24; C08K 3/34

(52) U.S. Cl. 428/36.92; 524/451; 423/331

(57) ABSTRACT

The use of talc as a fire performance modifier in polymer compositions is disclosed, in which the talc is present in an amount less than 30 percent by weight of the total weight of the polymer composition, and also in amounts ranging from 5 to 30 percent by weight of the polymer composition. In such polymer compositions, the impact performance of the composition is not compromised, the composition, for example, being useful in manufacture of plastic and polymer based pallets for storage and for warehouse use. Talc is disclosed to act as a fire performance modifier and char agent at concentrations as low as 5 weight percent in polymer compositions by modifying the Heat Release Rate shown by, first, lowering the Peak Heat Release, and second, by shortening the time period to reach the Peak Heat Release compared to the virgin polymer resin.

This invention relates to methods of using talc as a fire performance modifier in polymer compositions.

Every year there are thousands of deaths and millions of dollars of damage caused by fires. US Fire Loss Report, 2009, http://www.nfpa.org/publicJournalDetail.asp. Fire fatalities are caused primarily by inhalation of the smoke and gases (80%) emitted by fire, followed by burns (13%). Lew, C. F. “Flammability testing: fighting fire with fire.” To reduce the deaths and property damage from fire, fire retardants are employed to slow or control the progress of a fire.

Fire retardants are defined as compounds or compositions that are added, for example, during the production of polymer compositions or polymer based products, to prevent ignition of the composition or products or to suppress an initiated fire by extending the time required to reach the flashover point of such a polymer-based/plastic system. As used herein, the flashover point of a fire describes the near simultaneous ignition of all of the combustible material in an enclosed area and occurs when the majority of the flammable gases associated with an ignited fire reach their auto-ignition temperature. In contrast, a fire performance modifier is defined as a compound or composition that modifies the Heat Release Rate curve for a particular composition in two ways: (1) it decreases the Peak Heat Release, and (2) it shortens the time period needed to reach Peak Heat Release.

Particular fire performance modifiers may be able to modify the Heat Release Rate curve by acting as a char agent. As used herein, char agent means an agent which swells and chars when exposed to fire. Although fire retardants and fire performance modifiers are not necessarily the same, and, in fact can be distinct, a fire retardant may also be a fire performance modifier. Both fire retardants and fire performance modifiers may help to prevent or reduce the hazard of fires.

Among the most effective fire retardants are halogenated organic compounds such as decabromodiphenyl ether. However, manufacturers are moving away from the use of halogenated fire retardant compounds to low halogen or non-halogen fire retardant compounds. Non-halogen compositions comprising fire retardants or fire performance modifiers are advantageous because they have low smoke, low corrosion, low toxicity, and improved ecology characteristics. Flame Retardants for Plastics, P. Dufton, 2003, pg. 14. The low smoke produced by non-halogen compositions comprising fire retardants or fire performance modifiers enhances the visibility in the area surrounding the fire and thus increases the time and opportunities available to exit the fire area. The reduced corrosion results from eliminating the halogen acid gases produced by the halogenated fire retardant compounds, which can corrode and damage equipment during and after a fire. Non-halogen compositions comprising fire retardants or fire performance modifiers also have a lower toxicity that is achieved by eliminating the harmful halogen gases produced during a fire and an improved ecology achieved by eliminating the halogens in the materials which need to be recycled. For example, see http://www.bromine-info.org/en/are-brfs-safe/halogenated-flame-retardants/.

Since manufacturers have long used halogenated compounds as fire retardants, many halogenated compounds are well known for use in polymer applications where fire retardancy is desired or required. Other well-known halogenated fire retardant components which would be advantageously replaced with a non-halogenated compound include, for example, decabromodiphenyl ethane, poly-pentabromo acrylate, ethylene bis-tetrabromophtalimide, brominated polystyrene, tetrabromobisphenol A, and dechlorane. Of this group of halogenated fire retardant compounds, the most widely used is decabromodiphenyl ether (DecaBDE). Its use in the production of polymer based compositions for which fire retardant characteristics are desired and in fire retardant compositions that are subsequently transformed into or used in useful industrial and commercial articles such as electronic equipment, vehicles, aircrafts, building materials, and polyolefin based plastic pallets intended for use in warehouses and transportation systems, is well known. Such useful articles include, inter alia, all articles and underlying compositions employed in industries where the products require fire performance certifications or ratings under various respective industry-known standards, such as, but not limited to, UL 94, UL 2335, ASTM E 119, ASTM E 814, ASTM E 84, and ASTM E 136.

As with most halogenated fire retardant compounds, decabromodiphenyl ether has been found to pose serious risks to human health, wildlife, and the environment because it can be released during manufacturing, use and disposal of products in which it is used. DecaBDE persists in the environment and can degrade into other toxic halogen-containing chemicals over time. Eliminating or at least decreasing its use in manufacturing is thus needed and desired.

In December 2009, the US Environmental Protection Agency (EPA) announced a ‘DecaBDE Phase-Out Initiative’ designed to eliminate the production, importation and use of DecaBDE in the manufacture of U.S. goods/articles by 2013. In addition, several states have already passed legislation to ban DecaBDE for use in certain articles such as plastic pallets for storage and warehouse uses, in particular, and The European Union's Restriction of Hazardous Substances Directive (RoHS) has prohibited the use of DecaBDE in electronics and electrical equipment since July 2006. See for example http://www.inchem.org/documents/ehc/ehc/ehc192.htm#SectionNumber:7.4. Thus, there is a need for the development of more environmentally friendly non-halogen based fire retardant compositions.

An alternative to halogenated fire retardants are mineral or inorganic fire retardant compositions and fire performance modifier compositions. Mineral or inorganic fire retardant and fire performance modifier compositions typically do not contain any halogens, thus avoiding the problems with toxicity and damage to the environment found with the use of halogenated fire retardant compounds. Many mineral or inorganic fire retardant compositions are also well known, for example alumina trihydrate (AHT); magnesium compounds including magnesium hydroxide; boron compounds; and phosphorus oxide compounds. Mineral or inorganic based fire retardant compounds, such as ATH and magnesium hydroxide, may undergo an endothermic decomposition into aluminum oxide or magnesium oxide respectively, and water, which are non-toxic and non-corrosive decomposition products.

Mineral or inorganic fire retardant compositions have been used in the production of a variety of plastic and polymer-based products that require some degree of fire retardancy, such as the afore-mentioned industries with products requiring fire performance certifications. However, these fire retardant compositions generally contain minerals or inorganic compounds at high concentrations, such as above 30 wt %, based on the weight of the total polymer-based compositions. See for example http://www.cefic-efra.com/Objects/2/Files/IntroInorganicFactsheets.pdf. The mineral or inorganic compounds may be present in these compositions at high concentrations, and may function, for example, as a fire retardant and/or as a filler. The high concentrations of the mineral or inorganic compounds may result in an undesirable decreased performance of the polymer or decreased desirable characteristic of the final product. Historically, a trade-off has been forced between the desire for increased fire retardancy and for maximizing the desirable performance characteristics of polymer based compositions and products. For example, reduction of strength (tensile, compression), a loss in toughness and a change in heat resistance are common problem as are changes in appearance (color, gloss, transparency) and physical properties (density, hardness, melting and glass transition temperatures, thermal expansion and contraction) often change significantly. Electrical properties, such as resistance and dielectric constant are also frequently altered. Thus, there is a need for the development of a mineral or inorganic fire retardant composition or fire performance modifier composition which could be present in a variety of useful polymer compositions at lower concentrations than previously known without losing the ability to influence the fire performance of the polymer compositions, and while maintaining the most desirable performance characteristics of the polymer.

Fires can be broken down into four phases: 1) ignition; 2) flame spread; 3) Heat Release, and 4) release rates for smoke, toxic gases, and corrosive products. Fire Safety Journal 18 (1992) 255-272. In accordance with this breakdown, most mineral or inorganic fire retardant compositions seek to affect a fire's ignition or flame spread, rather than alter its Heat Release Rate like a fire performance modifier composition. However, studies have shown that “the most significant predictor of fire hazard is the Heat Release Rate.” Fire Safety Journal 18 (1992) 255-272; 269. As used herein, the Heat Release Rate is the rate at which energy is generated by a fire and can be shown by a standard heat release curve of heat release rate versus time. The Heat Release Rate can be viewed as the engine driving the progress of a fire and this tends to create positive-feedback for the fire with generated heat creating more heat. See, for example, http://www.interfire.org/features/heat_release.asp. The Heat Release Rate could, for example, be modified to decrease the time to the Peak Heat Release or lower the heat release rate level at which Peak Heat Release occurs. As used herein, the Peak Heat Release is the highest point on the heat release rate axis of the heat release rate versus time Heat Release Rate curve. Thus, a fire performance modifier may be able to reduce the possible fire hazard of a polymer based composition by altering the Heat Release Rate of the composition.

Another relevant aspect involved in the suppression of fires is the production of char during the combustion of some flammable materials. As used herein, char means a non-combustible external layer that protects the underlying material from igniting by creating a thermal insulation barrier between the burning and unburned parts of flammable material, slowing heat transfer to the unburned material and decreasing the amount of combustible gases emitted. The production of char may be the mechanism by which a fire retardant composition or a fire performance modifier composition ultimately reduces the associated fire hazard. Mineral and inorganic, as well as halogenated, fire retardant compositions or fire performance modifier compositions may produce char, thus acting as a char agent. However, as previously noted, the current state of the art regarding mineral or inorganic fire retardants involves compositions that generally include total filler (inorganics) concentrations above 30 wt % based on the weight of the total composition. For example, the use of inorganic compounds such as magnesium hydroxide at levels above 50 wt % as a fire retardant in low density polyethylene/ethylene vinyl acetate blends used in the electronic cabling industry is well known. See for example: Journal of Ceramic Processing Research. Vol. 10, No. 4, pp. 571-576 (2009). Thus, a fire performance modifier may be able to modify the Heat Release Rate curve by acting as a char agent.

Typically, a mineral or inorganic filler will have a Heat Release Rate curve similar to curve A in FIG. 1. A char agent will exhibit a Heat Release Rate curve similar to curve C in FIG. 1. As can be seen in FIG. 1, curve C has a decreased Peak Heat Release and a shortened the time period to reach Peak Heat Release compared to curve A. Curve C also has an increased overall ignition time, as shown by the elongation of the curve after the Peak Heat Release. A fire performance modifier, as disclosed herein, will exhibit a Heat Release Rate curve similar to curve C in FIG. 1.

Talc is a well known filler or inorganic component for use in polymer, and in particular polyolefin, compositions. Talc can be added at various stages in the polymer production to improve or modify the mechanical properties of these resins, including without limitation, tensile properties, shrinkage, and coefficient of linear thermal expansion compared to conventional polyolefin compositions containing inorganic components in an amount greater than 30% wt based on the total polyolefin composition. See: Chapter 9—Fillers and Reinforcements by Dr. A. W. Bosshard and Dr. H. P. Schlumpf in Plastics Additives, 2nd Ed., Hanser Publishers, New York, N.Y., 1987. ISBN 3-446-15072-2. Talc has also been used in conjunction with other fire retardant compositions such as magnesium hydroxide. See for example: Kim, S., Flame retardancy and smoke suppression of magnesium hydroxide filled polyethylene; J. Polym. Sci. B Polym. Phys., 2003, vol. 41, issue 9, pg. 936-944. However there is no discussion in the scientific literature of the affirmative use of talc independently to modify a polymer composition's Heat Release Rate. Likewise, there is no discussion of talc independently acting as a fire performance modifier in polymer based or plastic compositions and products. Additionally, it has not been shown previously that talc can act as a char agent when present in an amount that is below the total amount of filler in conventional filled polymer compositions, i.e., where talc is present, for example, in an amount less than approximately 30% w/w of the total composition. Accordingly, talc has also not been shown previously to independently modify the Heat Release Rate of a polymer composition by acting as a char agent.

### BRIEF DESCRIPTION OF DRAWINGS

FIG. 1. Typical Heat Release Rate Curves from Cone calorimetry

FIG. 2. Heat Release Rate Curves for Virgin Polymers and Polymers with Different Levels of Talc to Illustrate Fire Performance Modifier Properties of Talc

### DETAILED DESCRIPTION OF THE INVENTION

Polymer compositions comprising talc wherein the talc functions as a fire performance modifier, and, in particular, as the sole fire performance modifier, have been prepared and shown to demonstrate advantageous fire altering capabilities.

First, the talc, when added to a polymer based composition, even at low levels such as 5 wt % based on the total weight of the polymer composition, acts as a fire performance modifier by affecting the Heat Release Rate performance of the polymer composition in calorimetry tests. The Heat Release Rate performance is modified by the addition of the talc to the composition in two ways. The Heat Release Rate performance is modified, first, by decreasing the Peak Heat Release and second, by shortening the time period to reach the Peak Heat Release compared to the virgin resin. Decreasing the height of and shortening the time to the Peak Heat Release means that the hottest portion of the combustion process occurs earlier in the talc containing polymer composition compared to the virgin resin. The hottest portion of the combustion process is expected to set off fire suppression systems, for example, sprinkler systems. Thus, by having the fire suppression systems set off earlier in the combustion process, the suppression systems are expected to have the most effect in preventing the spread of fire to adjacent portions of the flammable material and to adjacent articles.

Second, the addition of talc to a polymer composition modifies its fire performance properties by increasing the composition's overall ignition time, as shown by the elongation of the heat release rate curve after the Peak Heat Release occurs as compared to the curve for the virgin resin. The ignition time increase indicates that the talc prevents the spread of heat which it may do by two possible mechanisms. First, the talc may be absorbing the initial energy of the combustion. By doing this, the talc may be altering the heat release capacity, which is the maximum potential of the material to release combustion heat in a fire or flame. Second, the talc may be suppressing the flammable vapors needed to support the ignition of the composition by forming a char layer at the ignition site. When talc is added to a polymer composition, the talc may, for example, be dispersed throughout the polymer matrix. Due to talc's plate-like structure, its particles may overlap as the polymer matrix is burned away. This may result in the talc forming a char layer that insulates the remaining polymer from the heat of the fire and acts as a barrier to the release of flammable gases, meaning that the talc may be acting as a char agent.

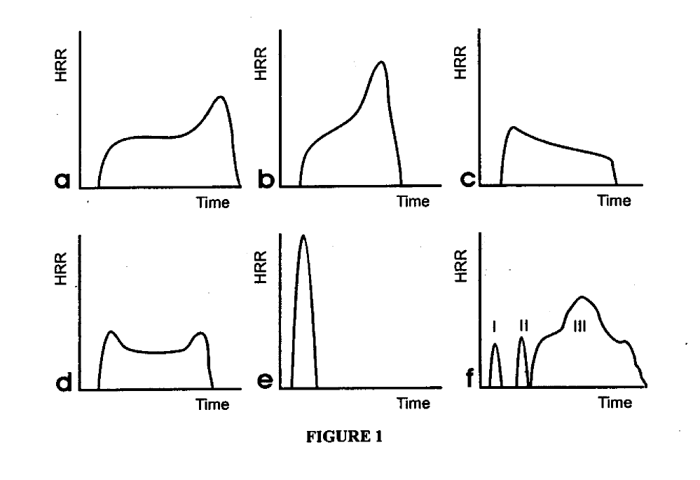

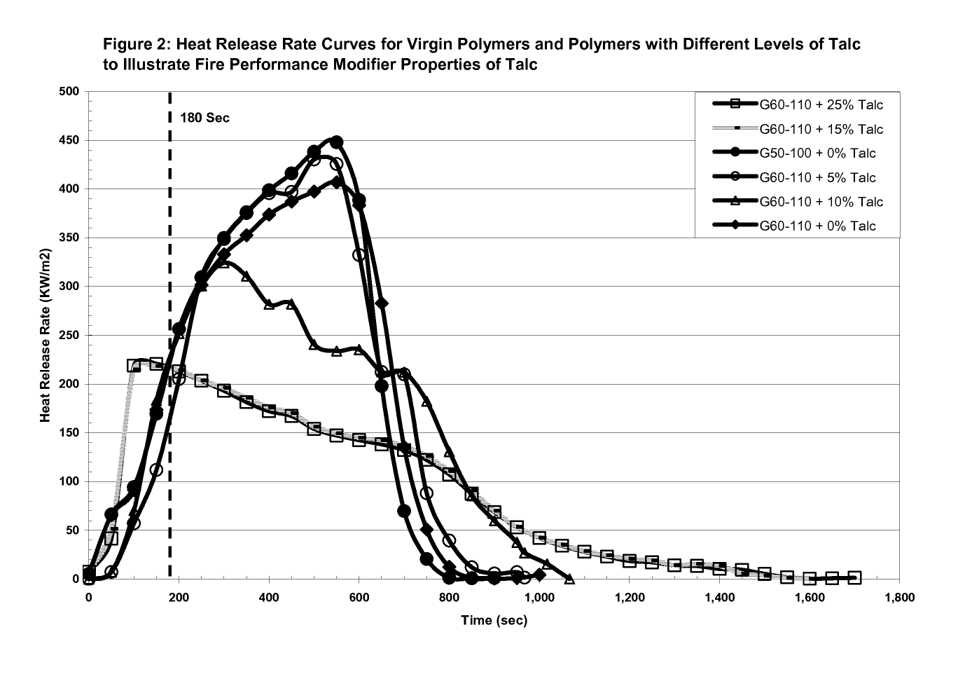

Talc's ability to act as a char agent is shown by the Heat Release Rate curves in FIG. 2. The Heat Release Rate curves in FIG. 2 are similar to curve C in FIG. 1. Talc's ability to shift a polymer composition to a curve similar to curve C in FIG. 1 is unexpected because most common inorganic fillers used in polymer compositions such as glass or silica, would exhibit a curve similar to curve A in FIG. 1.

Thus, as demonstrated by FIG. 2, talc has been shown for the first time to be a fire performance modifier by (1) decreasing the Peak Heat Release, and (2) shortening the time period to reach Peak Heat Release on a Heat Release Rate curve. Talc also acts as a fire performance modifier by increasing the composition's overall ignition time which may result from talc's unexpected ability to act as a char agent.

As used herein, the Heat Release Rate, the Peak Heat Release Rate, and the ignition time may be measured by Cone calorimetry. Cone calorimetry can be performed, for example, using a cone calorimeter from Fire Testing Technology Limited of Great Britain. The technique used for performing the Cone calorimetry may be, for example, the standard technique described in ASTM Method D6113, Standard Test Method for Using a Cone calorimeter to Determine Fire-Test-Response Characteristics of Insulating Materials Contained in Electrical or Optical Fiber Cables or ASTM E2102 Standard Test Method for Measurement of Mass Loss and Ignitability for Screening Purposes Using a Conical Radiant Heater.

As used herein, talc may, for example, be comprised of magnesium silicate hydrate. The talc may also, or alternatively, for example, be comprised of silicon dioxide. Additional ingredients in the talc may, for example, comprise magnesium oxide, aluminum oxide, iron, quartz, and/or chlorite-group minerals. The talc may, for example, be a hydrate or may be anhydrous. Talc that may be used in accordance with the invention is available as MICROTUFF® 325F, MICROTUFF® AG 101, MICROTUFF® AG 609, MICROTUFF® AGD 609, or POLYBLOC®. The talc may, for example, be a surface treated grade or be a densified appearance grade. In general, any talc of similar size and size distribution to the aforementioned commercially available products and that occurs in platelet form can be used.

The talc may have a median particle size ranging from 0.5 to 2 microns, such as ranging from 0.8 to 1.8 microns, or further such as ranging from 0.8 to 1.1 microns. The talc particles useful with the invention are not within the median particle size considered to be nano particles.

As used herein, the polymer composition comprises, for example, at least one polyolefin. As used herein, polyolefin is a polymer produced from a simple olefin, also called an alkene with the general formula CₙH₂ₙ, as a monomer. The polymer composition does not comprise any polymers with inherent fire retardant or fire performance modifying capabilities. For example, the polymer may comprise or consist of polyethylene and/or polypropylene. The polymer may also be a copolymer, for example a copolymer of ethylene and an alpha olefin such as, but not limited, to 1-hexene and butene and/or an impact copolymer polypropylene. The polymer may have more than two comonomers. The polymer may also be a blend of polyolefins. For example, a possible polymer comprising comonomers that may be used in accordance with the invention includes G50-100 from INEOS® Olefins & Polymers, which is a high molecular weight, high density polyethylene copolymer, and the like. Also, for example, possible homopolymers which may be used in accordance with the invention may be G60-110 from INEOS® Olefins & Polymers, which is a high molecular weight, high density polyethylene homopolymer, and the like.

When using polyethylene as the polyolefin, the polyethylene may be a high molecular weight, high density polyethylene. As a high molecular weight polyethylene, the molecular weight can be 150,000 g/mol or higher. The high density polyethylene may have a density ranging from 0.940 to 0.963 g/cc, such as ranging from 0.950 to 0.962 g/cc and, for example measured using ASTM Method D 4883. The polyethylene may have a melt index ranging from 0.1 to 15 g/10 min at 190° C./21600 g, such as ranging from 0.1 to 11.0 g/10 min at 190° C./21600 g, for example, measured according to ASTM Method D 1238. A copolymer of polyethylene may have a molecular weight of 150,000 g/mol or higher. When using polypropylene as the polyolefin, the polypropylene may be a high molecular weight polypropylene. The polypropylene may have a molecular weight ranging from 150, 000 g/mol and higher. Additionally, the polypropylene may have a melt flow rate ranging from 0.1 to 5.0 g/10 min at 230° C./2160 g, for example as measured according to ASTM Method D 1238 A copolymer of polypropylene may have the same molecular weight range and melt flow rate range as the homopolymer polypropylene.

The polymer compositions of the invention, in addition to talc and at least one polyolefin, may also comprise phenolic antioxidants, phosphorous based stabilizers and hindered amine stabilizers. Other possible additives may include carbon black. However, the talc and other mineral or inorganic additives do not exceed 30 wt % based on the weight of the total polymer composition. The polymer compositions furthermore do not comprise halogenated materials, for example halogenated fire retardant compositions, such as DecaBDE.

The talc may, for example, be added to the virgin polymer resin or may be added to a composition comprising the polymer. The talc may also be added in different stages of polymer production. For example, in one embodiment, the talc may be added to the virgin polymer at the initial compounding or densification stage. In another embodiment, the talc may be added to the polymer composition further downstream in processing. In another embodiment, the talc may be added in both the upstream and downstream processing portions of the polymer composition. The talc may also be added to the polymer as a component of a composition comprising talc. Further, the talc may be added separately as a master batch.

While talc is a filler known in the art and has been used in conjunction with fire retardant chemicals in polymer compositions, it has not previously been shown to function alone as a fire performance modifier when present in amounts below 30 wt % in a polymer composition. When present, talc has shown unexpected results by acting alone as a fire performance modifier in a polymer composition in low amounts, such as below 30 wt % based on the total weight of the polymer composition.

Additionally, talc has further shown unexpected results by functioning as a char agent in such polymer compositions in low concentrations, such as below 30 wt % as based on the total polymer composition. As used herein, char agent means an agent which swells and chars when exposed to flame. The ability of talc as a char agent even at low levels, to modify the ignition and burning characteristics of polymer compositions, is unexpected. Without the talc, the polymer composition would proceed to complete combustion in a short period of time and may exhibit flashover. Additionally, the talc appears to function as an char agent ingredient at a level that is generally well below the total amount of filler, which in conventional filled polymer compositions is above 30 wt % based on the total polymer composition. Likewise, other mineral and halogenated fire retardant compounds may perform a similar function but the current state of the art generally involves total filler concentrations well above 30 wt % as based on the total weight of the polymer composition.

The improvement in fire performance modification properties contributed by the talc-containing polymer compositions of the invention has also been observed to coincide with an increase in the flexural modulus of the resin compared to conventional polyolefin compositions containing inorganic components in an amount greater than 30% wt based on the total polyolefin composition. The addition of talc to the polymer composition may also improve the dimensional stability of the polymer composition.

The method of using talc as a fire performance modifier in a polymer composition at low concentration levels is important because increasing the concentration of talc and inorganics above 30 wt % based on the total weight of the polymer composition leads to compositions which may have reduced impact performance, strength, rigidity, toughness, and/or heat resistance. Good impact performance is a desired polymer characteristic especially for the plastic pallet, tote and container end use. Thus, using talc in accordance with the present invention may result in improved physical properties such as increased impact performance, strength, rigidity, toughness, ductility, and/or heat resistance compared to conventional polyolefin compositions containing inorganic components in an amount greater than 30% wt based on the total polyolefin composition.

If talc is omitted, the width of the Heat Release Rate curve for a particular polymer based composition is narrower and higher energy levels are achieved than those compositions wherein talc is present in low concentrations, such as below 30 wt % based on the total polymer composition. The use of talc in a polymer composition to act as a fire performance modifier may involve talc being present in an amount ranging from 5 wt % to 30 wt % as based on the total polymer composition. For example, the talc in such a composition may range from 5 wt % to 25 wt %, such as from 10 wt % to 25 wt %, further such as from 10 wt % to 15 wt %, and further such as 5 wt % to 10 wt % as based on the total polymer composition.

Polymer compositions comprising talc for its intended contribution as a fire performance modifier may, for example, be used for many useful industrial and commercial products, including storage pallets, electronics, and plastic storage containers such as crates, totes, bins and boxes. Furthermore, such useful products include, inter alia, all articles and underlying compositions employed in industries where the products require fire performance certifications or ratings under various respective industry-known standards, such as, but not limited to, UL 94, UL 2335, ASTM E 119, ASTM E 814, ASTM E 84, and ASTM E 136.

### EXAMPLE

The following example demonstrates the novel preparation and use of a composition comprising talc and polyolefin wherein the talc is used as a fire performance modifier in the polymer composition.

MICROTUFF® AG 609 talc was blended with a high molecular weight high density homopolymer polyethylene, G60-110 from INEOS®, primary and secondary stabilizers, such as phenolic antioxidants, phosphorous based stabilizers and hindered amine stabilizers, and extruded using a twin screw extruder and a strand pelletizer to form compositions containing various weight percentages of talc. These compositions were converted to various forms by techniques well known to those skilled in the art such as compression, sheet extrusion, and injection molding. Cone calorimetry was used to evaluate the fire performance of these compositions with regard to Time to Ignition and Heat Release Rate.

The data in Table 1 is provided for polyethylene compositions (polymer products used: INEOS® Olefins & Polymers G50-100 and G60-110) having talc content ranging between 5 wt % and 25 wt %, based on the total weight of the polymer composition. As can be seen from Table 1 and the related graph in FIG. 2, a composition comprising a 5 wt % of talc exhibits a measurable effect on the fire performance of the composition, as also shown by the change of the Heat Release Rate curve in FIG. 2, compared to the Heat Release Rate curve for the virgin polyethylene compositions. A 10 wt % talc loading is shown to dramatically decrease the energy given off, and increasing the talc loading to 15 wt % and 25 wt % further decreases the energy given off, as shown by the change in the Heat Release Rate curve in FIG. 2 compared to the virgin polyethylene compositions. The curve in FIG. 2 demonstrates the lowering and the shifting to an earlier point in time of the Peak Heat Release with the talc loading of 5 wt %, 10 wt %, and 25 wt % compared to the Peak Heat Release of the virgin polyethylene. Further, the talc loading ranging from 15 wt % to 25 wt % also shows a Peak Heat Release prior to 180 seconds, demonstrating the Peak Heat Release is achieved earlier in time. Additionally, the talc loading of 5 wt %, 10 wt %, and 25 wt % elongates the Heat Release Rate curve in FIG. 2, demonstrating a longer ignition time compared to the virgin polyethylene.

The data in Table 1 further show that the average time to ignition, as measured in seconds, increases with increased talc loading. Increased talc loading also results in an decreased average heat release rate. The increased talc loading results in a decreased average heat of combustion, average peak heat release, and average total heat release.

TABLE 1

| | | Average | Average | Average | Average | Average |
|---|---|---|---|---|---|---|
| | | Ignition | Heat of | HRR. at | Peak | Total Heat |
| Sample | | Time sec. | Combustion kJ/g | 180 s * | HRR kW/m² ** | mJ/m² |
| 1. | G50-100 | 51 | 41.5 | 130.7 | 464.7 | 204.3 |
| 2. | G60-110 | 51 | 41.5 | 133.4 | 440.7 | 204.3 |
| 3. | G60-110 + 5% Talc | 60 | 41.3 | 166.9 | 457.5 | 192.8 |
| 4. | G60-110 + 10% Talc | 73 | 40.4 | 224.0 | 341.9 | 177.9 |
| 5. | G60-110 + 15% Talc | 84 | 39.1 | 234.3 | 274.1 | 161.5 |
| 6. | G60-110 + 25% Talc | 87 | 40.3 | 210.2 | 232.4 | 154.2 |

* Heat Release Rate (HRR) is the rate at which heat is generated by fire.
** Peak Heat Release Rate is the highest point on the Heat Release curve and corresponds to the maximum energy given off

MICROTUFF® AG 609 talc was obtained from Specialty Minerals, Inc. of Bethlehem, Pa. G50-100 a high molecular weight, high density polyethylene copolymer produced by INEOS® Olefins & Polymers; G60-110 a high molecular weight, high density polyethylene homopolymer produced by INEOS® Olefins & Polymers

1. A polyolefin composition comprising a fire performance modifier, wherein the fire performance modifier consists essentially of talc.

2. The polyolefin composition according to claim 1, wherein the talc is present in an amount less than 30 wt % based on the total weight of the polyolefin composition.

3. The polyolefin composition according to claim 2, wherein the talc is present in an amount ranging from 5 to 30 wt % based on the total weight of the polyolefin composition.

4. The polyolefin composition according to claim 3, wherein the talc is present in an amount ranging from 5 to 25 wt % based on the total weight of the polyolefin composition.

5. The polyolefin composition according to claim 4, wherein the talc is present in an amount ranging from 10 to 15 wt % based on the total weight of the polyolefin composition.

6. The polyolefin composition according to claim 4, wherein the talc is present in an amount ranging from 5 to 15 wt % based on the total weight of the polyolefin composition.

7. The polyolefin composition according to claim 4, wherein the talc is present in an amount ranging from 10 to 20 wt % based on the total weight of the polyolefin composition.

8. The polyolefin composition according to claim 1, wherein the polyolefin comprises at least one polyolefin chosen from polyethylene and polypropylene.

9. The polyolefin composition according to claim 1, wherein the talc ranges in median particle size from 0.5 to 2 microns.

10. The polyolefin composition according to claim 1, wherein the talc is present in an amount that demonstrates at least one improved mechanical or physical property for the polyolefin composition compared to conventional polyolefin compositions containing inorganic components in an amount greater than 30% wt based on the total weight of the polyolefin composition.

11. The polyolefin composition according to claim 10, wherein the at least one improved mechanical property may be chosen from tensile properties, shrinkage, and coefficient of linear thermal expansion.

12. The polyolefin composition according to claim 10, wherein the at least one improved physical property may be chosen from increased impact strength and increased ductility.

13. The polyolefin composition according to claim 1, wherein the polyolefin composition is used for the manufacture of a polymer based storage pallet, tote, or container.

14. The polyolefin composition according to claim 1, wherein the talc functions as a char agent.

15. A polyolefin composition comprising a fire performance modifier, wherein the fire performance modifier consists essentially of talc and wherein the composition achieves fire retardancy.

16. The polyolefin composition according to claim 15, wherein the talc is present in an amount ranging from 5 to 30 wt % based on the total weight of the polyolefin composition.

17. A fire performance modifier for use in a polyolefin composition, said composition comprising at least one polyolefin and a heat release rate curve altering amount of talc, wherein said talc is present in an amount ranging from 5 to 30 wt % based on the total weight of the polyolefin composition.

18. A fire performance modifier for use in a polyolefin composition according to claim 17, wherein said heat release rate curve is altered by reducing the peak heat release rate and shortening the time period to reach peak heat release of said polyolefin composition as compared to the peak heat release and time period to reach peak heat release of said polyolefin composition lacking any talc.

19. A fire performance modifier for use in a polyolefin composition according to claim 17, wherein said polyolefin composition demonstrates at least one improved mechanical or physical property for the polyolefin composition compared to conventional polyolefin compositions containing inorganic components in an amount greater than 30% wt based on the total weight of the polyolefin composition.

20. A fire performance modifier for use in a polyolefin composition, said fire performance modifier consisting essentially of talc.

21. The fire performance modifier for use in a polyolefin composition according to claim 20, wherein the talc is present in an amount ranging from 5 to 30 wt % based on the total weight of the polyolefin composition.

22. A fire performance modifier for use in a polyolefin composition according to claim 17, wherein said heat release rate curve is altered by talc functioning as a char agent.

23. A method for modifying the fire performance of a polyolefin composition, said method comprising including in said polyolefin composition a fire performance modifier, wherein the fire performance modifier consists essentially of talc.

24. A method for modifying the fire performance of a polyolefin composition, said method comprising including in said polyolefin composition a heat release rate curve altering amount of talc, wherein said talc is present in an amount ranging from 5 to 30 wt % based on the total weight of the polyolefin composition.

25. A method for modifying the fire performance of a polyolefin composition according to claim 24, wherein said heat release rate curve is altered by reducing the peak heat release rate and shortening the time period to reach peak heat release of said polyolefin composition as compared to the peak heat release and time period to reach peak heat release of said polyolefin composition lacking any talc.

26. A method for modifying the fire performance of a polyolefin composition according to claim 24, wherein said heat release rate curve is altered by talc functioning as a char agent.

27. A polyolefin composition comprising at least one polyolefin and talc, wherein as compared to said polyolefin composition lacking any talc, when said polyolefin compositions are evaluated with cone calorimetry, the heat release rate curve is modified such that the peak heat release is reduced, the time period to reach peak heat release is shortened and the time to ignition is increased.

28. A method for making a polymer based or plastic storage container, pallet or tote, said method comprising forming said container, pallet or tote from the polyolefin composition according to claim 1.

29. An article of manufacture made from the polyolefin composition according to claim 1.

30. The article of manufacture according to claim 29, wherein said article is a polymer based or plastic storage container, pallet or tote.

31. A pallet for use in warehouse operations comprising the polyolefin composition of claim 1.

32. A container for use in warehouse operations comprising the polyolefin composition of claim 1.

33. A tote for use in warehouse operations comprising the polyolefin composition of claim 1.

34. The use of the polyolefin composition according to claim 1 to meet a fire performance rating chosen from UL 94, UL 2335, ASTM E 119, ASTM E 814, ASTM E 84, and ASTM E 136.
